(19) United States
(12) Patent Application Publication
(10) Pub. No.: US 2017/0335854 A1
(43) Pub. Date: Nov. 23, 2017

(54) External Dryer Vent Lint Blower

(71) Applicant: Victor Allen Wilson, Arlington, TX (US)

(72) Inventor: Victor Allen Wilson, Arlington, TX (US)

(21) Appl. No.: 15/158,215

(22) Filed: May 18, 2016

(51) Int. Cl. F04D 25/08; F04D 17/08; F04D 25/06; D06F 58/22; F04D 29/28; F04D 29/42; F04D 29/70

(52) U.S. Cl. CPC F04D 25/082; F04D 29/4206; F04D 17/08; F04D 29/703; D06F 58/22; F04D 29/281; F04D 25/06; F05B 2240/14; F05B 2240/20

(57) ABSTRACT

An electric powered lint blower that includes a housing body having an air intake and outlet, the outlet designed to force air flow through a tube connected to the blower housing and out through the dryer vent exhaust of a building structure. The housing further comprising a detachable component part having an intake opening to receive air flow from a clothes dryers, exhaust vent, and intake opening to receive air from the External Dryer Vent Lint Blower and an opening to expel air into the dryer exhaust vent of a building or structure. The electric motor comprising an attached impeller to generate a powerful air flow. A power supply cord. A second power cord attached to control the power—on/off positions of a power ON/OFF switch.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### THE NAMES OF THE PARTIES TO A JOINT RESEARCH AGREEMENT IF THE CLAIMED INVENTION WAS MADE AS A RESULT OF ACTIVITIES WITHIN THE SCOPE OF A JOINT RESEARCH AGREEMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The present invention relates generally to dryer vent blowers designed for the specific purpose of blowing lint which is expelled from a clothes dryer, into the dryer vent shaft of a building structure, such as a house, apartment, or other commercial or residential structures. The present invention relates more specifically to an External Electric Dryer Vent Lint Blower and an attachable and detachable apparatus. The attachable and detachable apparatus comprising an air intake opening designed for attachment to the exhaust vent of a clothes dryer, an additional air intake opening designed for attachment to the air outlet of the External Dryer Vent Lint Blower and an air outlet opening designed for attachment to the dryer exhaust vent opening of a building or structure.

Dryer vent blowers are typically built within the housing of clothes dryers and powered by the same power source, electricity or gas, as the dryer in which they are housed. Such internal vents are typically of a type in which the internal motor generates a low velocity air flow most often not sufficiently powerful enough to fully expel lint from the dryer through the dryer vent or up the vertical shaft opening of dryer vents built within the walls of structures. This low velocity air flow typical in blowers built within the internal housing of clothes dryers allows for the accumulation of lint within the dryer vent and the vent shaft. Such lint accumulations present multiple problems and hazards for dryer owners, users, and residents of structures housing dryers. A brief listing of shortcomings presented by dryer lint blowers currently available in the marketplace, though not all inclusive, are: the accumulation of lint in the dryer vent and vent shaft can make clothes drying less efficient thereby increasing drying time and therefore increasing utility consumption and cost; by causing clothes dryers to operate less efficiently, lint accumulation can also shorten the useful life cycle of clothes dryers; further, the accumulation of lint due to inefficient removal can cause clothes dryers to operate hotter and overheat, potentially presenting a fire hazard.

An additional problem presented by low air velocity internally built dryer blowers, which allow the accumulation and buildup of lint within the dryer vent shaft of structures, is the subsequent need to clean, remove lint from the dryer vent shaft thereby presenting a maintenance cost of vent cleaning.

Dryer blowers that are built within the dryer and operate on the same power source as the dryer, require the dryer to be in the on position and operational to power the blower.

### BRIEF SUMMARY OF THE INVENTION

The External Dryer Vent Lint Blower accomplishes the objects and overcomes all prior stated difficulties and short comings of prior art and dryer vent blowers currently available in the marketplace in the following manner:

The External Dryer Vent Lint Blower reduces and/or eliminates the accumulation of lint within the dryer vent and dryer exhaust vent of the building structure.

The present invention helps to improve the efficiency of clothes dryer operation by more efficiently and effectively clearing lint from the dryer vent and dryer exhaust vent shaft, thereby potentially extending the operational life span of the dryer and potentially reducing drying time and possibly reducing utility cost.

The present invention through improved dryer lint removal efficiency can potentially reduce the probability of a dryer overheating thereby potentially reducing the risk of fire hazard.

The present invention through improved efficiency in dryer lint removal can potentially reduce the need and frequency of manual dryer vent cleaning.

The External Dryer Vent Lint Blower operates on a separate independent power source thereby eliminating the need to operate the dryer in an effort to clear lint from the dryer vent.

### BRIEF DESCRIPTION OF THE SEVERAL VIEWS OF THE DRAWINGS

FIG. 1 Depicts a right side view of the External Dryer Vent Lint Blower

FIG. 2 Depicts a left side view of the External Dryer Vent Lint Blower

FIG. 3 Depicts an overhead view of the External Dryer Vent Lint Blower and the apparatus designed to attach the External Dryer Vent Lint Blower to the Dryer Blower and the Dryer Exhaust Vent of a structure.

FIG. 4 Depicts a right side cut-away view of the External Dryer Vent Lint Blower

FIG. 5 Depicts a front facing view of the External Dryer Vent Lint Blower

FIG. 6 Depicts an overhead cut-away view of the External Dryer Vent Lint Blower

### DETAILED DESCRIPTION OF THE INVENTION

Now referencing specifically the drawings to aid in describing the present invention:

It is quite possible to construct or manufacture this invention using a variety of materials and methods. The invention is also susceptible to various modifications. The drawings depicting the invention and these subsequent detailed descriptions of the drawings are not intended to place limitations on the claims of the inventor. These drawings and their descriptions are in no way intended to limit the invention to the specific form as disclosed. This invention is, however, intended to cover all modifications, methods, and alternative constructions and any subsequent equivalents within the spirit of the invention as described and claimed.

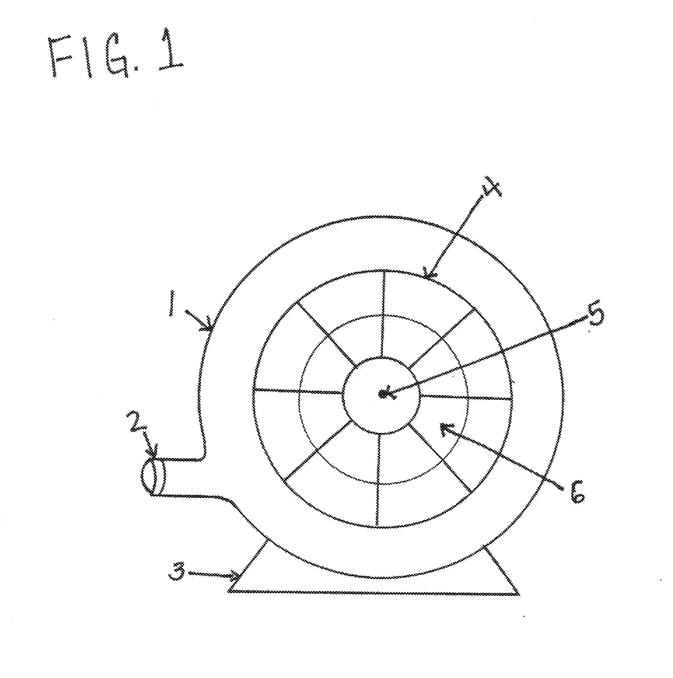

The External Dryer Vent Lint Blower (1) depicted in FIG. 1, the blower air outlet (2) FIG. 1 and the stabilizer stand (3) FIG. 1 are to be constructed of hard molded plastic formed and shaped in two halves and connected together using rivets or screws (not depicted).

FIG. 1 (4) depicts removable plastic cover over open air area to allow air flow to enter to assist in cooling the electric motor. FIG. 1 (5) depicts a screw designed for the removal and re-attachment of the open air area plastic cover. FIG. 1 (6) depicts a filter designed to prevent dust from entering in to the interior of the External Dryer Vent Lint Blower.

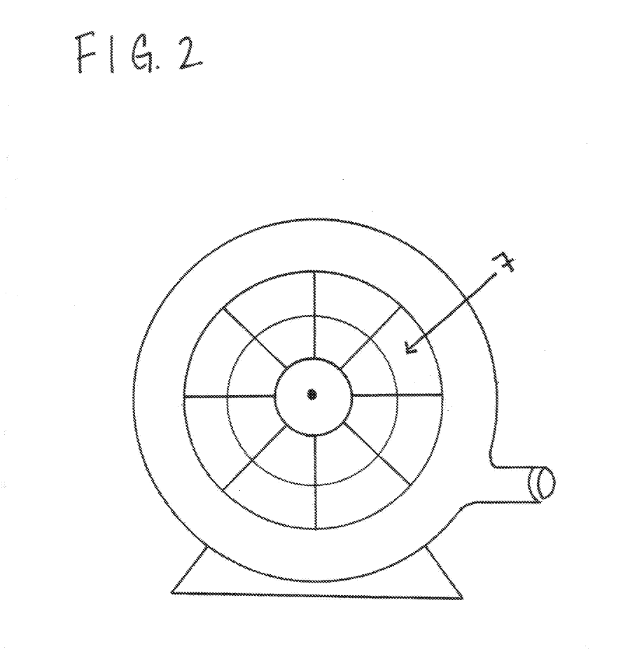

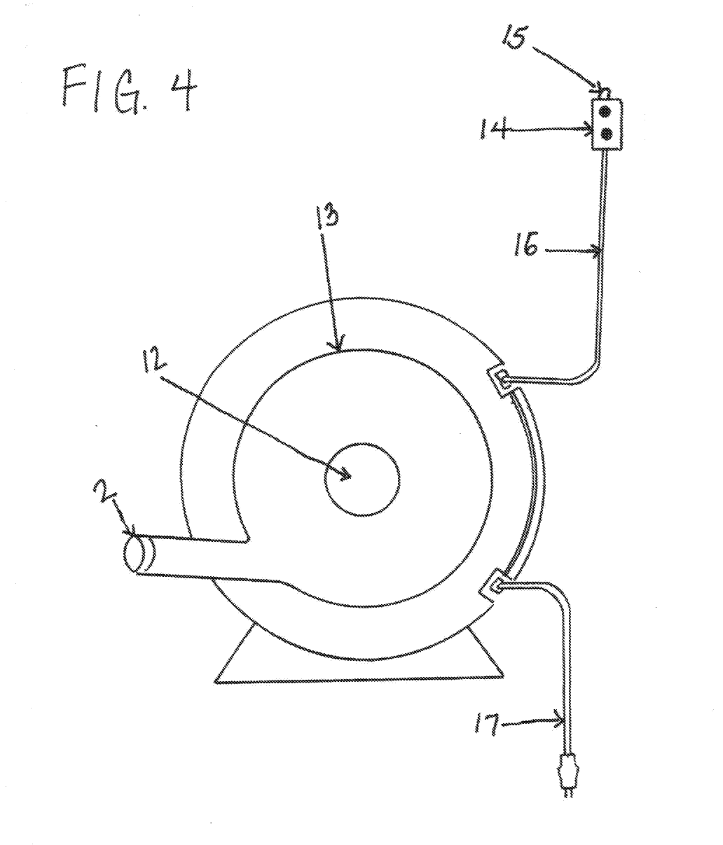

FIG. 2 (7) depicts the air intake area and filter. Though the depictions as drawn show the airflow intake on the left side of the External Dryer Vent Lint Blower, the design is such that it shall be left to the discretion of the manufacturer to position the electric motor FIG. 4 (12) in such a manner as is necessary for sufficient operation of the External Dryer Vent Lint Blower.

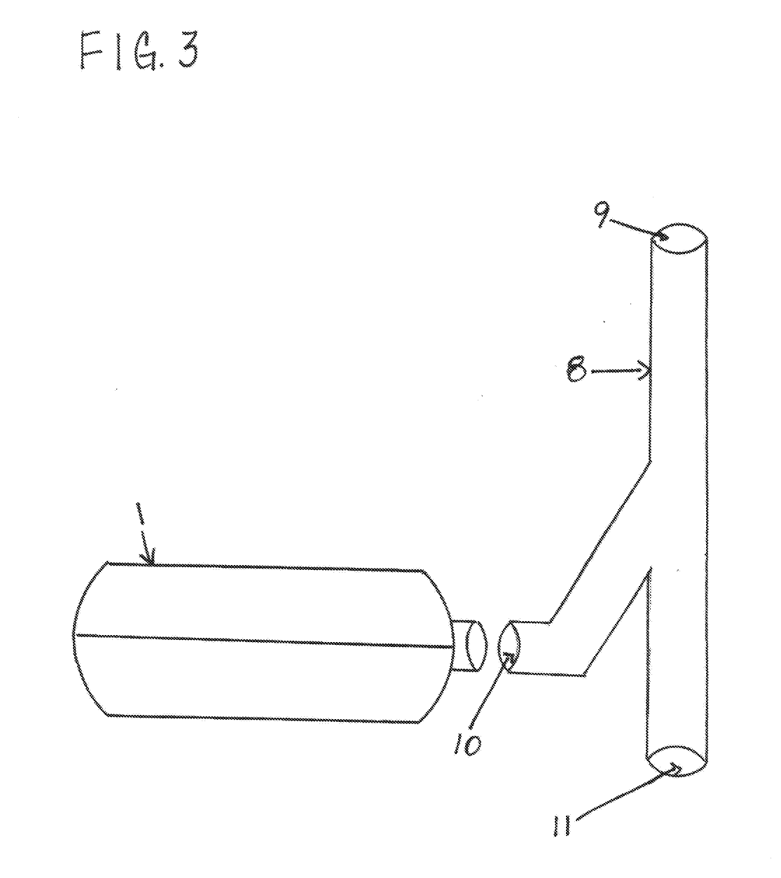

FIG. 3 depicts an overhead view of (1) External Outer housing of the External Dryer Vent Lint Blower and (8) the connector attachment device designed to connect the External Dryer Vent Lint Blower to the lint exhaust vent of a structure or building via opening (9) of the attachment and to the air outlet of the External Dryer Vent Lint Blower via opening (10) of the attachment and to the dryer air flow outlet via opening (11) of the attachment. All connections to be made via dryer vent flex duct and/or clamps (not pictured) where necessary.

FIG. 4 depicts (12) electric motor with attached impeller (impeller not pictured), (13) volute housing through which air velocity pressure is generated, (2) air outlet, (14) power ON/OFF switch, (15) bracket with hole for screw attachment, designed to mount (14) power ON/OFF switch to wall, (16) Power ON/OFF switch power cord, (17) power supply cord.

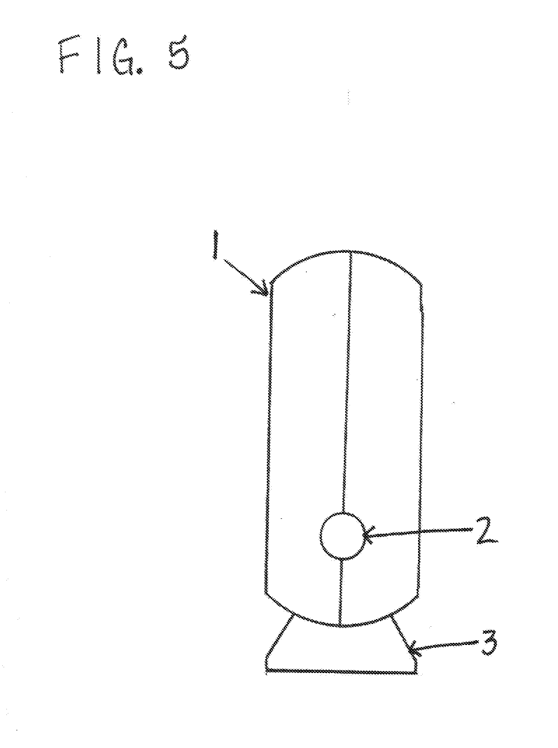

FIG. 5 depicts a front view of (1) the External Dryer Vent Lint Blower (2) the air flow outlet opening and (3) the stabilizer stand of the External Dryer Vent Lint Blower.

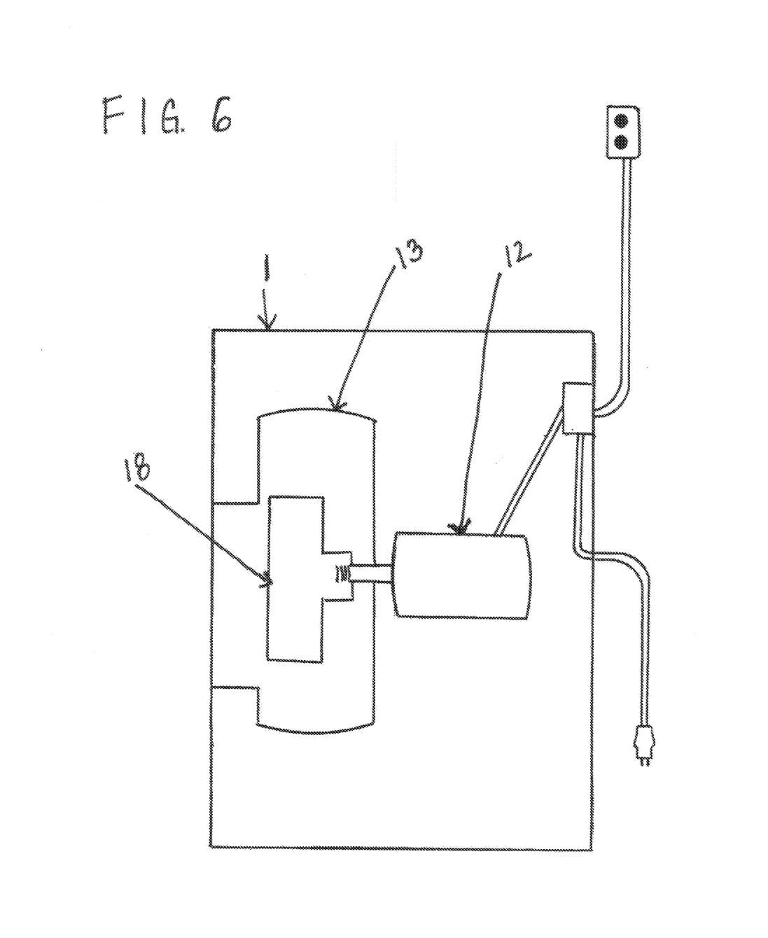

FIG. 6 depicts a cut-away overhead view of the (1) External Housing of the External Dryer Vent Lint Blower, (13) the volute housing and (18) the air impeller attached to (12) the Electric Motor.

1. An electric powered, electric, motor with an impeller attached thereto, designed to rotate the impeller, the impeller situated inside a housing volute, the housing volute fan housing comprising an air inlet and air outlet, the rotating impeller designed to draw air in through the air inlet significantly increase the pressure of air and expel the air out through the air outlet of the fan housing; an on-off power switch attached, via a power cord, to the electric motor to supply and interrupt power flow to the electric motor in a manner as to power the electric motor on and off, an electric power cord attached thereto, to supply power from a standard household or building structure wall power outlet;

2. The External Dryer Vent Lint Blower of claim 1, having an on-off switch that is operated by a digit of the users' hand to alternatively power on and off the electric motor of the External Dryer Vent Lint Blower;

3. An external attachment device tubular in shape and of similar material and manufacture as the outer housing of the External Dryer Vent Lint Blower of claim 1, designed with three openings in a configuration that facilitates the attachment and detachment to the airflow outlet of the External Dryer Vent Lint Blower of claim 1, the dryer vent airflow outlet of a clothes dryer and the external dryer vent airflow exhaust outlet of a building or structure.
